(19) United States
(12) Patent Application Publication
(10) Pub. No.: US 2020/0128808 A1
(43) Pub. Date: Apr. 30, 2020

(54) FLYING INSECT TRAP

(71) Applicant: DOMOBIOS, Woluwe-Saint-Lambert (BE)

(72) Inventors: Anne-Catherine MAILLEUX, Genval (BE); Gwendoline CLOTUCHE, Court-Saint-Etienne (BE); Manhattan SOLHEID, Ovifat/Waimes (BE); Alice MANGHI, Ixelles (BE); Céline PEETERS, Molenbeek-Saint-Jean (BE)

(21) Appl. No.: 16/628,813

(22) PCT Filed: Jul. 6, 2018
(86) PCT No.: PCT/EP2018/068427

§ 371 Date: Jan. 6, 2020

(30) Foreign Application Priority Data
Jul. 7, 2017 (CA) 2972725
Jul. 7, 2017 (EP) 17180310.9

(51) Int. Cl. A01M 1/10; A01M 1/04; A01M 1/14

(52) U.S. Cl. CPC A01M 1/106; A01M 1/14; A01M 1/04

(57) ABSTRACT

The present invention relates to a flying insect trap (1) having a cuboid shape comprising at least two intersecting interior walls (2b) forming a line of intersection (5), each interior wall being disposed between two opposite edges (3) and forming at least one acute angle with an exterior wall (2a).

### FIELD OF INVENTION

The present invention relates to pest control, particularly to flying insects, and more particularly to ladybug pest control.

### BACKGROUND OF INVENTION

Many groups of flying insects are considered as domestic or/and agricultural pests. In some cases, thousands of individuals can cluster together, for example nesting in large numbers within homes, causing serious problems for inhabitants.

This is particularly the case for ladybirds, also known as ladybugs or lady beetles, (in particular Harmonia axyridis) which colonize houses and fields when temperatures decline (autumn period). They form mass overwintering aggregations and may cause concern to residents, especially because of the foul-smelling liquid produced by those insects, which may also stain fabrics. Furthermore, some people are allergic to this liquid. The peak of this autumn activity is restricted to a few weeks only, but once inside wandering ladybirds may occur on mild days throughout the winter.

Lady beetles are also considered as an agricultural pest in many winemaking regions of the world due to their ability to negatively affect wine quality when present with the fermenting juice. In some cases, contaminated juice has to be discarded, representing important economic losses for the wine industry.

There is actually no effective and non-toxic solution available on the market to control populations of this invasive insect. Actually, ladybirds are removed using a vacuum cleaner or eradicated using an aerosol or residual insecticide spray. In practice, the eradication is conducted by a technician. The US patent application US2003/208952 discloses a device for insects which has the shape of a prism.

However, there is still a need for an effective and non-toxic solution to control populations of invasive flying insects.

The Applicant shows that forms, angles and colors may have an important impact on insect traps effectiveness. The present invention thus relates to a trap for flying insects having a cuboid shape and comprising at least one acute angle.

### SUMMARY

The present invention relates to a flying insect trap having a cuboid shape comprising at least one interior wall forming at least one acute angle with one exterior wall.

In one embodiment, the angle ranges from 10° to 80°, preferably from 30° to 60°. In a preferred embodiment, the said angle is about 45°.

In one embodiment, the at least one interior wall is disposed between two edges of opposite faces of said cuboid. In one embodiment, the interior wall is a plane wall.

In one embodiment, the trap of the invention comprises at least two intersecting interior walls.

Thus, the present invention also relates to a flying insect trap having a cuboid shape and comprising at least two intersecting interior walls, each interior wall forming an acute angle with at least one exterior wall of the trap, wherein said at least two interior walls are disposed between two edges of opposite exterior walls of the trap. In one embodiment, said intersecting interior walls are plane walls.

In one embodiment, the line of intersection formed by the two intersecting interior walls is continuous on at least 50% of its length, preferably at least 75% of its length.

In one embodiment, the trap of the invention further comprises at least one interior panel forming an acute angle with at least one interior wall. In one embodiment, the trap of the invention comprises four of said interior panels.

In one embodiment, the external surface of the trap of the invention is light colored. In one embodiment, the external surface of the trap of the invention is light reflective.

In one embodiment, the trap of the invention comprises an aperture disposed in a corner of the trap, an aperture disposed in the middle of an edge of the trap and/or an aperture disposed in the middle of an exterior wall of the trap. In one embodiment, the trap comprises an aperture disposed in a corner of the trap. In one embodiment, said aperture is a rectangular aperture, a triangular aperture or a round aperture. In one embodiment, the total surface area of aperture(s) present in the trap of the invention represents less than about 40% of the total surface area of said trap, preferably less than about 30% of the total surface area of said trap.

In one embodiment, the internal surface of at least one wall is covered by a sticky substance. In one embodiment, the internal surface of at least one exterior wall or the surface of at least interior wall is covered by a sticky substance.

In one embodiment, the trap further comprises an attractive agent. In one embodiment, the trap further comprises a desiccant substance.

In one embodiment, the flying insect is a beetle. In a preferred embodiment, the beetle is a ladybird.

The present invention also relates to a method for trapping flying insects, said method comprising a step of providing a flying insect trap as defined hereinabove.

### Definitions

In the present invention, the following terms have the following meanings:
The term “about” is used herein to mean approximately, roughly, around, or in the region of. When the term “about” is used in conjunction with a numerical range, it modifies that range by extending the boundaries above and below the numerical values set forth. In one embodiment, the term “about” is used herein to modify a numerical value above and below the stated value by a variance of 20 percent, preferably of 10 percent, more preferably of 5 percent.
The term “exterior walls” as used herein refers to the walls of the trap of the invention defining its outside shape. Thus, in one embodiment, the trap of the invention is a rectangular parallelepiped, preferably is a cuboid, and the exterior walls of the trap correspond to the faces of the rectangular parallelepiped or cuboid.
The term “interior walls” as used herein refers to walls comprised within the trap of the invention. In a particular embodiment, the interior wall is disposed between two edges of opposite exterior walls, i.e., between two diagonally opposed edges. Thus, in one embodiment, the trap of the invention comprises one or two interior wall(s), each disposed between two diagonally opposed edges of the trap. Alternatively, in one embodiment, the interior wall is disposed between the center of the trap and an edge of the trap. Thus, in one embodiment, the trap of the invention comprises one, two, three or four interior wall(s), disposed between the center of the trap and an edge of the trap and meeting at the center of the trap.
The term “interior panels” as used herein refers to panels comprised within the trap of the invention. Thus, an interior panel is a particular type of interior wall. According to the present invention, an interior panel of the trap is a panel that is not disposed between two edges of the trap (in particular between two diagonally opposed edges of the trap) or between the center of the trap and an edge of the trap. In one embodiment, an interior panel of the trap is a panel that extends from the center of the trap towards one exterior wall of the trap, preferably towards the middle or center of said exterior wall to which it is thus perpendicular. In one embodiment, said interior panel does not reach the exterior wall of the trap. In one embodiment, said interior panel reaches the exterior wall of the trap.

### BRIEF DESCRIPTION OF THE D WINGS

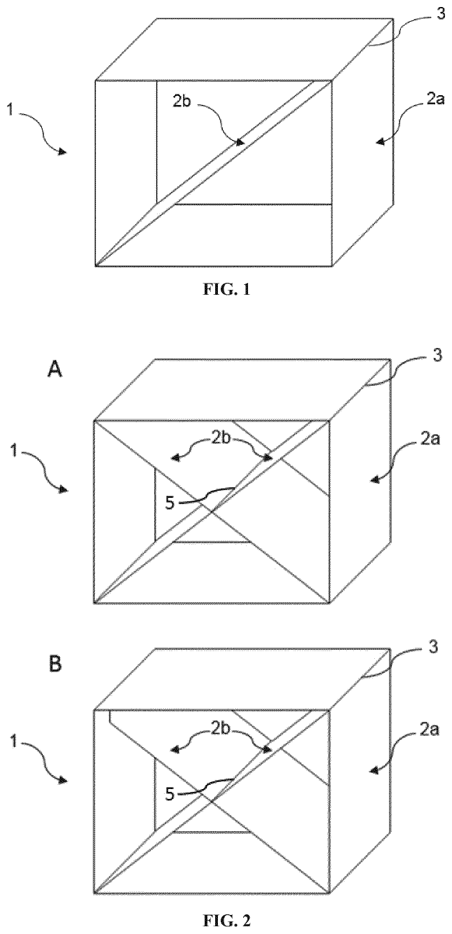

FIG. 1 is a perspective view of a first embodiment of a trap according to the present invention having a cuboid shape and comprising one interior wall.

FIG. 2A is a perspective view of a second embodiment of a trap according to the present invention having a cuboid shape and comprising two intersecting interior walls. FIG. 2B is a perspective view of a third embodiment of a trap according to the present invention having a cuboid shape and comprising two intersecting interior walls, one of the interior wall being a truncated wall.

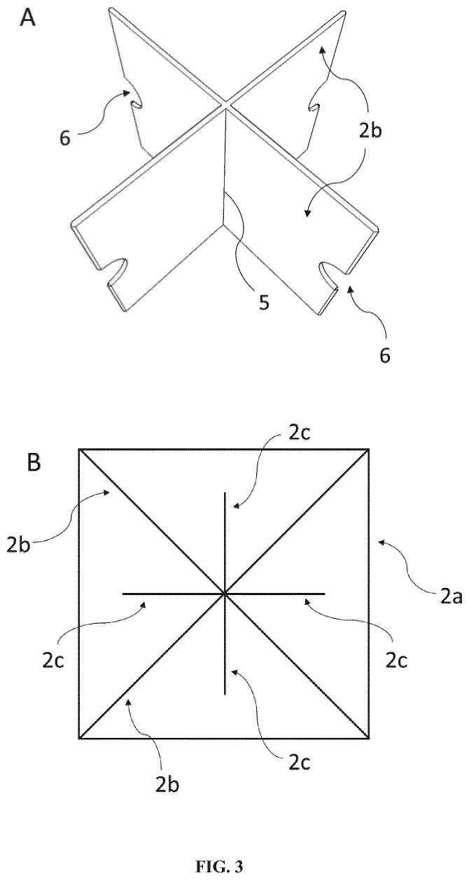

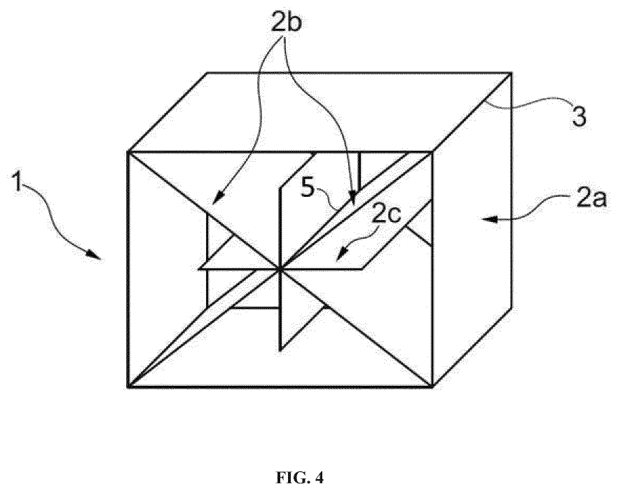

FIG. 3A is a three-dimensional view of two intersecting interior walls that are comprised in a fourth embodiment of a trap according to the present invention, said interior walls having a notch in the middle of two of their edges. FIG. 3B is a cross-sectional view of a fifth embodiment of a trap according to the present invention having a cuboid shape and comprising two intersecting interior walls and four interior panels.

FIG. 4 is a perspective view of said fifth embodiment of a trap according to the present invention having a cuboid shape and comprising two intersecting interior walls and four interior panels.

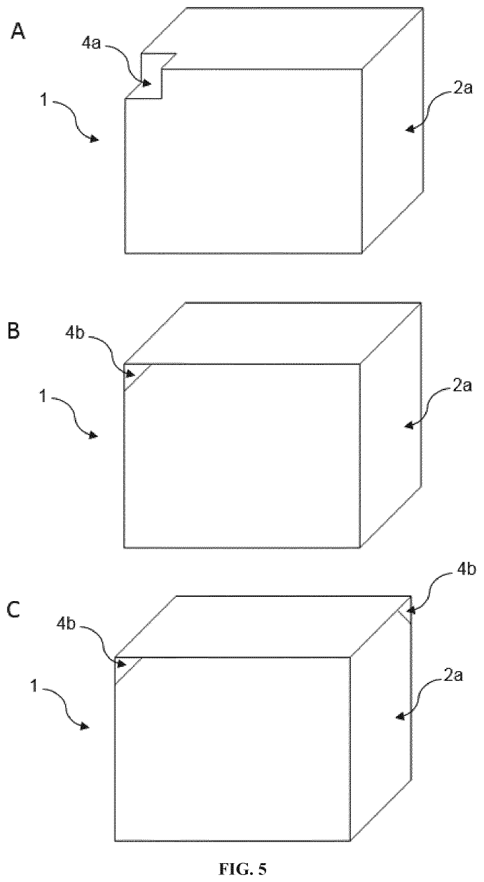

FIG. 5A is a perspective view of a sixth embodiment of a trap according to the present invention having a cuboid shape and comprising a rectangular aperture disposed in a corner. FIG. 5B is a perspective view of a seventh embodiment of a trap according to the present invention having a cuboid shape and comprising a triangular aperture disposed in a corner. FIG. 5C is a perspective view of an eight embodiment of a trap according to the present invention having a cuboid shape and comprising two triangular apertures disposed in two corners.

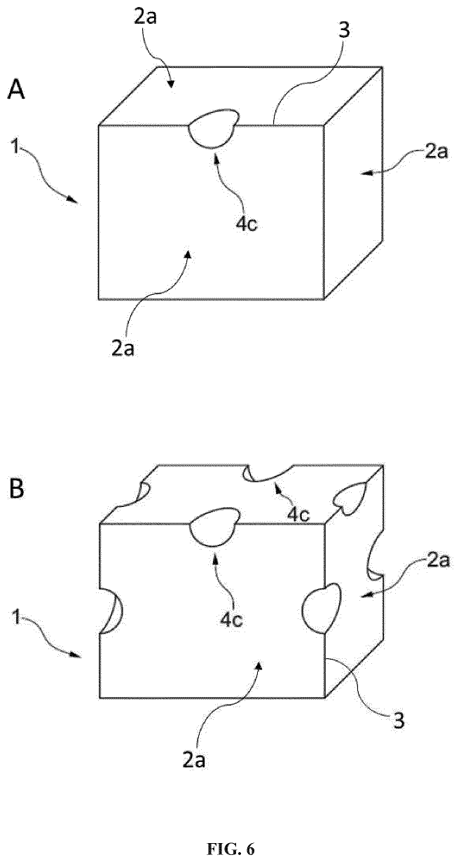

FIG. 6A is a perspective view of a ninth embodiment of a trap according to the present invention having a cuboid shape and comprising a round aperture in the middle of an edge of the trap, said aperture corresponding to the projection of a circle on the two exterior walls of the cuboid trap defining the edge of the trap. FIG. 6B is a perspective view of a tenth embodiment of a trap according to the present invention having a cuboid shape and comprising eight round apertures, each round aperture being in the middle of an edge of the trap and corresponding to the projection of a circle on the two exterior walls of the cuboid trap defining the edge of the trap. According to this embodiment, all the edges of the trap except for the four edges at the bottom of the trap comprise a round aperture disposed in their middle.

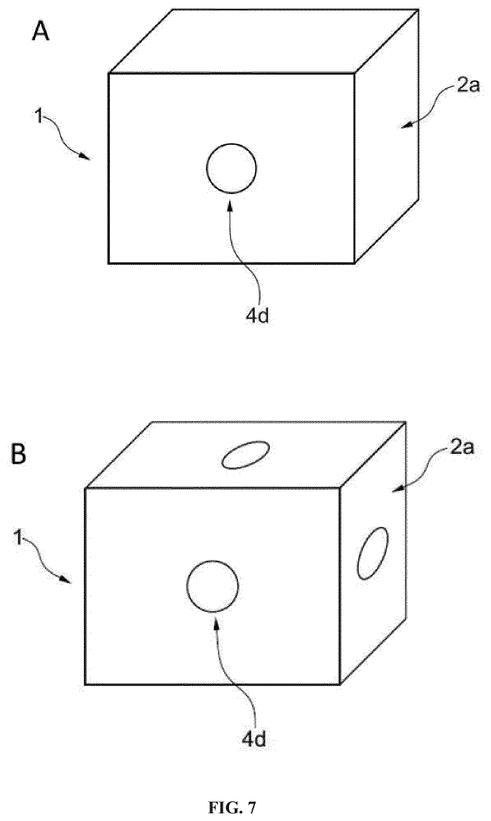

FIG. 7A is a perspective view of an eleventh embodiment of a trap according to the present invention having a cuboid shape and comprising a round aperture in the middle of an exterior wall of the trap. FIG. 7B is a perspective view of a twelfth embodiment of a trap according to the present invention having a cuboid shape and comprising six round apertures, each aperture being in the middle of an exterior wall of the trap. According to this embodiment, all the exterior walls of the trap comprise a round aperture disposed in their middle.

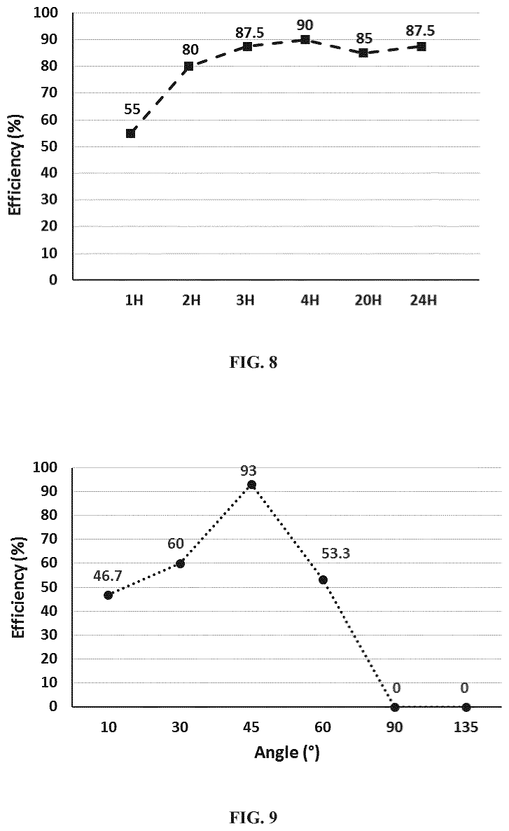

FIG. 8 is a graph showing the efficiency (%) according to the time (in hours) of a glittering cuboid trap comprising intersecting interior walls.

FIG. 9 is a graph showing the efficiency (%) of traps according to the angle between the walls of the trap.

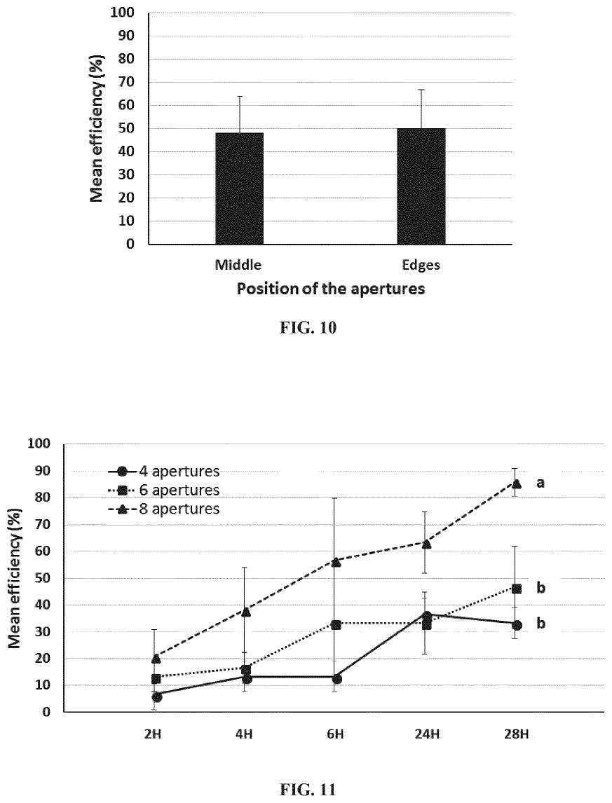

FIG. 10 is a histogram showing the mean efficiency (%) of traps according to the position of their apertures. Traps comprising 4 round apertures were tested, with each round aperture being positioned either in the middle of an exterior wall of the trap (“Middle”) or in the middle of an edge of the trap (“Edges”).

FIG. 11 is a graph showing the mean efficiency (%) of traps over time (in hours) according to the number of apertures of the traps. Traps with either 4, 6 or 8 round apertures positioned in the middle of an edge of the trap were tested. The mean efficiency is significantly different between traps indicated with (a) and traps indicated with (b) but is not significantly different among traps indicated with the same letter (i.e., (b)).

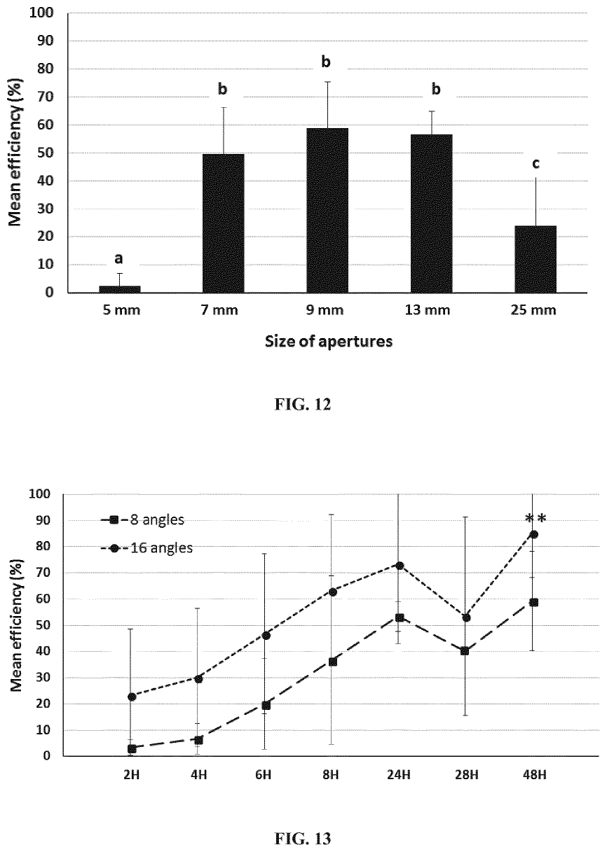

FIG. 12 is a histogram showing the mean efficiency (%) of traps according to the size of their apertures. Traps with 8 round apertures were tested, with each round aperture being positioned in the middle of an edge of the trap and having the indicated diameter (ranging from 5 mm to 25 mm). The mean efficiency is significantly different between traps indicated with (a), traps indicated with (b) and traps indicated with (c) but is not significantly different among traps indicated with the same letter (i.e., (b)).

FIG. 13 is a graph showing the mean efficiency (%) of traps over time (in hours) according to the number of acute angles within the traps. Traps with either 8 or 16 acute angles were tested.

### DETAILED DESCRIPTION

Flying insects, such as ladybirds, like to move along edges, in particular along edges with sharp angles.

Therefore, this invention relates to a flying insect trap having a cuboid shape and comprising at least one acute angle. As used herein, the term “acute angle” may be replaced by “sharp angle” and means angle of less than 90°. As used herein, the term “cuboid” may be replaced by “parallelepiped”.

In one embodiment, the invention has the shape of a rectangular parallelepiped. In a particular embodiment, the trap of the invention has the shape of a cube, i.e., a cuboid shape. Thus, in one embodiment, the trap of the invention is referred to as a cuboid trap or cubic trap.

In one embodiment, walls may be exterior walls or interior walls. In one embodiment, walls may be exterior walls, interior walls or interior panels. As used herein, exterior walls of the trap of the invention, in particular of the cuboid trap, may be referred as faces of the trap or as sides of the trap. In one embodiment, the trap of the invention comprises at least four exterior walls. In another embodiment, the trap of the invention comprises at least five exterior walls. In one embodiment, the trap of the invention comprises five exterior walls. In another embodiment, the trap of the invention comprises six exterior walls. In another embodiment, the trap of the invention comprises more than 6 exterior walls.

In one embodiment, at least one of the exterior walls of the trap of the invention is openable, removable or detachable. In other words, at least one of the exterior walls of the trap of the invention functions as a lid and may be removed at will.

Means allowing at least one exterior wall of a rectangular parallelepiped, or cuboid, to be openable, removable or detachable are well-known to the skilled artisan. For example, the at least one openable, removable or detachable exterior wall may be encased by its adjacent exterior walls or may slide along its adjacent exterior walls. Alternatively, at least one exterior wall may be openable through the means of a hinge.

In one embodiment, the trap of the invention, in particular the cuboid trap of the invention, comprises six exterior walls, at least one of said exterior walls being removable.

In one embodiment, the trap of the invention, in particular the cuboid trap of the invention, comprises five exterior walls, with the open face of the trap serving as the basis of the trap, to be placed or attached on a support such as, for example, a floor, a ceiling, a wall, the bottom of a wardrobe, or the top of a furniture. According to this embodiment, the open face of the trap of the invention, i.e., the basis of the trap of the invention, is closed by the support on which the trap is placed.

In one embodiment, the trap of the invention comprises at least one interior wall. In one embodiment, the trap of the invention comprises at least one interior wall forming an acute angle with at least one exterior wall of the trap.

In one embodiment, the trap of the invention comprises at least two, three, four, five, six, seven or eight interior walls. In one embodiment, the trap of the invention comprises two interior walls. In one embodiment, the trap of the invention comprises two interior walls, each forming an acute angle with at least one exterior wall of the trap. In another embodiment, the trap of the invention comprises four interior walls. In another embodiment, the trap of the invention comprises four interior walls, each forming an acute angle with at least one exterior wall of the trap.

According to a particular embodiment of the invention, the interior wall as described hereinabove is disposed between two opposite edges of the trap. As used herein, the term “two opposite edges” means that said edges do not share a common adjacent exterior wall. In other words, in a particular embodiment, the interior wall is disposed between two diagonally opposed edges of the trap. An example of an interior wall disposed between two opposite edges of a cuboid trap is illustrated in FIG. 1. To put it another way, in said particular embodiment, the interior wall is disposed between two edges of opposite exterior walls. As used herein, the terms “two opposite exterior walls” or “two opposite faces” mean parallel exterior walls or parallel faces of the trap. Thus, according to a particular embodiment of the invention, the trap of the invention comprises one or two interior wall(s), disposed between two edges of opposite exterior walls of the trap. In one embodiment, the interior wall(s) extend(s) from one edge of the cuboid to a diagonally opposed edge of the cuboid.

In one embodiment, the trap of the invention comprises one interior wall disposed between two diagonally opposed edges of the trap as illustrated in FIG. 1. In a preferred embodiment, the trap of the invention comprises two intersecting interior walls disposed between two diagonally opposed edges of the trap as illustrated in FIG. 2.

Alternatively, according to another embodiment of the invention, the interior wall as described hereinabove is disposed between the center of the trap of the invention and an edge of the trap of the invention. Thus, according to another embodiment of the invention, the trap of the invention comprises one, two, three or four interior wall(s), disposed between the center of the trap and an edge of the trap. In one embodiment, the interior wall(s) extend(s) from the center of the trap of the invention to an edge of the trap invention.

In one embodiment, the trap of the invention comprises two interior walls disposed between the center of the trap and an edge of the trap, said interior walls meeting at the center of the trap, as illustrated in FIG. 1. In another embodiment, the trap of the invention comprises four interior walls disposed between the center of the trap and an edge of the trap, said interior walls meeting at the center of the trap, as illustrated in FIG. 2.

According to one embodiment, the interior wall as described hereinabove is truncated at least in one place. Therefore, flying insects may move from one compartment delimited by a truncated interior wall to another compartment delimited by said interior wall. In one embodiment, the interior wall as described hereinabove does not extend over the whole length of the edge.

In one embodiment, the interior wall as described hereinabove is truncated in at least one of its corners. An example of an interior wall truncated in one of its corners is illustrated in FIG. 2B.

In one embodiment, at least one of the edges or ends or extremities of the interior wall that are in contact with an edge of the trap of the invention comprises at least one notch or nick or gap. In one embodiment, the two edges or ends or extremities of the interior wall that are in contact with an edge of the trap of the invention comprises at least one notch or nick or gap. An example of an interior wall comprising a notch in the two of its edges or ends or extremities that are in contact with an edge of the trap of the invention is illustrated in FIG. 3A.

In one embodiment, said notch or nick or gap is a rounded notch or a rounded nick or a rounded gap.

In one embodiment, said notch or nick or gap is positioned sensibly in the middle or center of said edge or end or extremity of the interior wall that is in contact with an edge of the trap of the invention. In one embodiment, said notch or nick or gap is positioned in the middle or center of said edge or end or extremity of the interior wall that is in contact with an edge of the trap of the invention. In one embodiment, said notch or nick or gap is positioned in the middle or center of said edge or end or extremity of the interior wall that is in contact with an edge of the trap of the invention so that the center of the notch or nick or gap overlaps with the center of said edge of the interior wall. An example of an interior wall comprising a rounded notch sensibly in the middle of two of its edges or ends or extremities that are in contact with an edge of the trap of the invention is illustrated in FIG. 3A.

In one embodiment, the interior wall as described hereinabove comprises a hole. In one embodiment, the interior wall as described hereinabove comprises a hole in its surface.

Therefore, flying insects which entered the trap by an aperture may reach other compartments. In particular, flying insects which entered the trap by an aperture may thus move from one compartment delimited by an interior wall comprising a hole to another compartment delimited by said interior wall. As an illustration, flying insects which entered the trap by an aperture in an upper corner may thus reach a bottom compartment. In one embodiment, the interior wall comprising a hole is not truncated. In one embodiment, the interior wall comprising a hole does not comprise a notch or nick or gap in one of its edges or ends or extremities that are in contact with an edge of the trap of the invention. In one embodiment, said hole is a rectangular hole, a square hole, a triangular hole or a round hole, for example a circular hole or an oval hole.

According to one embodiment, the trap of the invention comprises at least two interior walls that cross each other, thereby forming a line of intersection or intersected line or joint line. Thus, according to one embodiment, the trap of the invention comprises two intersecting interior walls.

In one embodiment, the two interior walls that cross each other and form a line of intersection, i.e., the two intersecting interior walls, are interior walls disposed between two edges of opposite exterior walls of the trap of the invention. Thus, in one embodiment, the two interior walls that cross each other and form a line of intersection, i.e., the two intersecting interior walls, are interior walls disposed between two diagonally opposed edges of the trap of the invention.

In one embodiment, the line of intersection or intersected line or joint line formed by the crossing of two interior walls disposed between two diagonally opposed edges of the trap of the invention is situated in the center of the trap of the invention.

In one embodiment, the line of intersection between the two intersecting interior walls, i.e., the line of intersection or intersected line or joint line formed by the crossing of two interior walls, in particular two interior walls disposed between two diagonally opposed edges of the trap of the invention, is continuous on at least 50%, 55%, 60%, 65%, 70%, 75%, 80%, 85%, 90% or 95% of its length, preferably on at least 75% of its length. Thus, in one embodiment, the line of intersection between the two intersecting interior walls, i.e., the line of intersection formed by the crossing of two interior walls, in particular two interior walls disposed between two diagonally opposed edges of the trap of the invention, is uninterrupted on at least 50%, 55%, 60%, 65%, 70%, 75%, 80%, 85%, 90% or 95% of its length, preferably on at least 75% of its length.

In one embodiment, the line of intersection between the two interior walls, i.e., the line of intersection or intersected line or joint line formed by the crossing of two interior walls, in particular two interior walls disposed between two diagonally opposed edges of the trap of the invention, is continuous. Thus, in one embodiment, the line of intersection between the two interior walls, i.e., the line of intersection or intersected line or joint line formed by the crossing of two interior walls, in particular two interior walls disposed between two diagonally opposed edges of the trap of the invention, is uninterrupted.

According to one embodiment, the trap of the invention further comprises at least one interior panel forming an acute angle with at least one interior wall of the trap. An example of interior panel forming an acute angle with at least one interior wall of the trap is illustrated in FIG. 4.

According to the present invention, an interior panel is a particular type of interior wall comprised within the trap of the invention.

In one embodiment, said interior panel of the trap is a panel that extends from the center of the trap towards one exterior wall of the trap, forming an acute angle with at least one interior wall of the trap.

In one embodiment, the trap of the invention comprises two intersecting interior walls disposed between two diagonally opposed edges of the trap forming an intersection line in the center of the trap and the interior panel of the trap as described hereinabove is a panel that extends from said line of intersection towards one exterior wall of the trap, forming an acute angle with at least one interior wall of the trap.

In one embodiment, said interior panel of the trap is a panel that extends from the center of the trap towards the middle or center of one exterior wall of the trap, to which it is perpendicular. An example of interior panel extending from the center of the trap towards the middle or center of one exterior wall of the trap, to which it is perpendicular, is illustrated in FIG. 4.

In one embodiment, said interior panel of the trap is a panel that extends from the line of intersection formed by two intersecting interior walls disposed between two diagonally opposed edges of the trap towards the middle or center of one exterior wall of the trap, to which it is perpendicular. An example of interior panel extending from said line of intersection towards the middle or center of one exterior wall of the trap, to which it is perpendicular, is illustrated in FIG. 4.

In one embodiment, said interior panel of the trap does not reach the exterior wall of the trap towards which it extends. In other words, in one embodiment, there is a gap between the interior panel of the trap and the exterior wall of the trap towards which it extends. In one embodiment, the trap is a cube and the length of said interior panel is less than half of the length of the side of the trap. An example of interior panel that does not reach the exterior wall of the trap towards which it extends is illustrated in FIG. 4.

In one embodiment, said interior panel of the trap extends from the center of the trap to an exterior wall of the trap. In other words, in one embodiment, said interior panel of the trap reaches the exterior wall of the trap towards which it extends. Thus, in one embodiment, there is no gap between the edge of the interior panel of the trap and the exterior wall of the trap towards which it extends. In one embodiment, the trap is a cube and the length of said interior panel is equal to half of the length of the side of the trap.

In one embodiment, said interior panel extending to an exterior wall of the trap is truncated. Therefore, flying insects may move from one compartment delimited by the truncated interior panel to another compartment delimited by said interior panel. In one embodiment, said interior panel extending to an exterior wall of the trap comprises at least one notch or nick or gap in at least one of its edges or ends or extremities that are in contact with an exterior wall of the trap.

In one embodiment, said notch or nick or gap is a rounded notch or a rounded nick or a rounded gap. In one embodiment, said notch or nick or gap is positioned sensibly in the middle or center of said edge or end or extremity of the interior panel that is in contact with an exterior wall of the trap of the invention. In one embodiment, said notch or nick or gap is positioned in the middle or center of said edge or end or extremity of the interior panel that is in contact with an exterior wall of the trap of the invention. In one embodiment, said notch or nick or gap is positioned in the middle or center of said edge or end or extremity of the interior panel that is in contact with an exterior wall of the trap of the invention so that the center of the notch or nick or gap overlaps with the center of said edge of the interior panel.

In one embodiment, said interior panel extending to an exterior wall of the trap comprises a hole. Therefore, flying insects which entered the trap by an aperture may move from one compartment delimited by an interior panel to another compartment delimited by said interior panel. In one embodiment, said hole is a rectangular hole, a square hole, a triangular hole or a round hole, for example a circular hole or an oval hole.

In one embodiment, the trap of the invention comprises one, two, three, or four interior panel(s) as described hereinabove.

In one embodiment, the trap of the invention comprises one interior panel as described hereinabove, said interior panel extending from the center of the trap towards an exterior wall.

In one embodiment, the trap of the invention comprises two interior panels as described hereinabove, said interior panels extending from the center of the trap towards two opposite exterior walls.

In one embodiment, the trap of the invention comprises two interior panels as described hereinabove, said interior panels extending from the center of the trap towards two adjacent exterior walls.

In one embodiment, the trap of the invention comprises three interior panels as described hereinabove, said interior panels extending from the center of the trap towards three adjacent exterior walls.

In one embodiment, the trap of the invention comprises four interior panels as described hereinabove.

In one embodiment, the trap of the invention comprises at least four exterior walls as described hereinabove and at least one interior wall as described hereinabove. In another embodiment, the trap of the invention comprises five exterior walls as described hereinabove and at least one interior wall as described hereinabove. In another embodiment, the trap of the invention comprises six exterior walls as described hereinabove and at least one interior wall as described hereinabove. In said embodiment, at least one of the exterior walls as described hereinabove comprises at least one aperture.

In one embodiment, the trap of the invention comprises at least four exterior walls as described hereinabove, at least two interior walls as described hereinabove and optionally at least one interior panel as described hereinabove. In another embodiment, the trap of the invention comprises five exterior walls as described hereinabove, at least two interior walls as described hereinabove and optionally at least one interior panel as described hereinabove. In another embodiment, the trap of the invention comprises six exterior walls as described hereinabove, at least two interior walls as described hereinabove and optionally at least one interior panel as described hereinabove. In said embodiment, at least one of the exterior walls as described hereinabove comprises at least one aperture.

An advantage of the trap of the invention is the high number of edges, along which insects may move, and angles, in particular acute angles, in which insects may aggregate.

In one embodiment, the at least one acute angle of the trap of the invention is between two exterior walls, between an exterior wall and an interior wall, or between two interior walls.

In one embodiment, the trap of the invention comprises at least one, two, three, four, five, six, seven, eight, nine, ten, eleven, twelve, thirteen, fourteen, fifteen, or sixteen acute angles. In one embodiment, the trap of the invention comprises, two, three, four, five, six, seven, eight, nine, ten, eleven, twelve, thirteen, fourteen, fifteen, sixteen or more acute angles.

In one embodiment, the trap of the invention comprises four acute angles, preferably formed between exterior walls and interior walls of said trap. An example of a trap of the invention comprising four acute angles is illustrated in FIG. 1.

In one embodiment, the trap of the invention comprises eight acute angles, preferably formed between exterior walls and interior walls of said trap. An example of a trap of the invention comprising eight acute angles is illustrated in FIG. 2.

In one embodiment, the trap of the invention comprises sixteen acute angles, preferably formed between exterior walls and interior walls of said trap and between interior walls and interior panels of said trap. An example of a trap of the invention comprising sixteen acute angles is illustrated in FIG. 4.

In one embodiment, the at least one acute angle of the trap of the invention is inferior or equal to 85°, 80°, 75°, 70°, 65°, 60°, 55°, 50°, 45°, 40°, 35° or less. In one embodiment, the at least one acute angle of the trap of the invention is comprised between 30° and 90°.

In one embodiment, the at least one acute angle of the trap of the invention ranges from 30° to 85°, from 35° to 80°, from 40° to 75°, from or 45° to 70°. In another embodiment, the at least one acute angle of the trap of the invention ranges from 30° to 60°, from 35° to 55° or from 40° to 50°. In a preferred embodiment, the at least one acute angle of the trap of the invention is about 45°.

According to an embodiment, the trap of the invention has a cuboid shape and comprises at least one interior wall.

In a particular embodiment, the interior wall is disposed between two opposite edges of the trap, i.e., between two diagonally opposed edges of the trap. As described hereinabove, the term “two opposite edges” means that said edges do not share a common adjacent wall. An example of an interior wall disposed between two opposite edges of a cuboid trap is illustrated in FIG. 1. In one embodiment, the at least one interior wall is disposed between an upper edge of the trap and a bottom edge of the trap.

In another embodiment, the interior wall is disposed between the center of the trap and an edge of the trap as described hereinabove.

In one embodiment, the trap of the invention comprises at least one interior wall forming at least one acute angle with one exterior wall of the cuboid.

According to a preferred embodiment, the trap of the invention has a cuboid shape and comprises two interior walls. In one embodiment, the trap of the invention has a cuboid shape and comprises two interior walls, each interior wall forming an acute angle with at least one exterior wall of the trap. In a particular embodiment, the two interior walls are each disposed between two opposite edges (i.e., disposed between two edges of opposite exterior walls, also referred to as opposite faces). In another embodiment, the interior walls are disposed between the center of the trap and an edge of the trap as described hereinabove.

An example of two interior walls each disposed between two opposite edges of a cuboid trap is illustrated in FIG. 2. In one embodiment, the two interior walls cross each other, thereby forming a line of intersection as described hereinabove.

In one embodiment, the two interior walls are each disposed between an upper edge of the trap and a bottom edge of the trap, as illustrated in FIG. 2B. As a consequence, in one embodiment, the line of intersection between the two interior walls is parallel to the top and bottom faces of the trap.

In another embodiment, the trap has a cuboid shape and comprises four interior walls meeting at the center of the trap, each interior wall being disposed between the center of the trap and an edge of the trap.

Flying insects also like to move along straight walls and along edges rather than on curved surfaces. Therefore, in one embodiment, the trap of the invention comprises straight walls. In one embodiment, the trap of the invention has not a spherical shape, or an ovoid shape, or a cone shape, or a circular-cylindrical shape. In one embodiment, the walls of the trap of the invention are plane walls. In a particular embodiment, the exterior walls of the trap of the invention are plane walls. In one embodiment, the interior walls of the trap of the invention are plane walls. In one embodiment, the interior panels of the trap of the invention are plane panels.

Thus, in one embodiment, the trap of the invention comprises plane exterior walls as described hereinabove, plane interior wall(s) as described hereinabove and optionally plane interior panel(s) as described hereinabove.

In one embodiment, the trap of the invention comprises at least one aperture for flying insects to move into the trap. In one embodiment, the trap of the invention comprises at least two, three, four, five, six, seven or eight apertures. In one embodiment, the trap of the invention comprises two, three, four, five, six, seven, eight, nine, ten, eleven, twelve or more apertures. In one embodiment, the trap of the invention comprises between one and twenty aperture(s), preferably between two and twelve apertures. In one embodiment, the trap of the invention comprises two apertures. In one embodiment, the trap of the invention comprises four apertures. In one embodiment, the trap of the invention comprises six apertures. In one embodiment, the trap of the invention comprises eight apertures.

In one embodiment, the aperture of the invention is a rectangular aperture, preferably a square aperture. In another embodiment, the aperture of the invention is a round aperture, for example a circular aperture or an oval aperture. In another embodiment, the aperture of the invention is a semi-circular aperture or a set of two semi-circular apertures. In another embodiment, the aperture of the invention is a triangular aperture.

In one embodiment, the trap of the invention comprises more than one aperture as described hereinabove and said apertures all have the same shape. Thus, in one embodiment, the trap of the invention comprises more than one aperture as described hereinabove and said apertures are all rectangular apertures, round apertures, semi-circular apertures or triangular apertures.

In another embodiment, the trap of the invention comprises more than one aperture as described hereinabove and said apertures do not all have the same shape. Thus, in one embodiment, the trap of the invention comprises rectangular aperture(s), round aperture(s), semi-circular aperture(s) and/or triangular aperture(s).

In one embodiment, the aperture of the invention is a square aperture with a side ranging from about 0.5 cm to about 2.5 cm, preferably from about 0.7 cm to about 2 cm.

In one embodiment, the aperture of the invention is a square aperture with a side of about 0.7, 0.8, 0.9, 1, 1.1, 1.2, 1.3, 1.4, 1.5, 1.6, 1.7, 1.8, 1.9, 2, 2.1, 2.2, 2.3, 2.4 or 2.5 cm.

In one embodiment, the aperture of the invention is a round aperture, preferably a circular aperture, with a diameter ranging from about 0.5 cm to about 2.5 cm, preferably from about 0.7 to about 2 cm.

In one embodiment, the aperture of the invention is a round aperture, preferably a circular aperture, with a diameter of about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, or 2.5 cm.

In one embodiment, the aperture of the invention is a semi-circular aperture with a diameter ranging from about 0.5 cm to about 2.5 cm, preferably from about 0.7 to about 2 cm.

In one embodiment, the aperture of the invention is a semi-circular aperture with a diameter of about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, or 2.5 cm.

In one embodiment, the surface area of the aperture(s) present in an exterior wall of the trap of invention represents less than about 40%, 35%, 30%, 25%, 20%, 15%, 10%, 5% or 2.5% of the surface area of said exterior wall. In one embodiment, the surface area of the aperture(s) present in an exterior wall of the trap of the invention represents less than about 20%, 19%, 18%, 17%, 16%, 15%, 14%, 13%, 12%, 11%, 10%, 9%, 8%, 7%, 6%, 5%, 4%, 3%, 2% or 1.5% of the surface area of said exterior wall. In one embodiment, the surface area of the aperture(s) present in an exterior wall of the trap of the invention represents less than about 5% of the surface area said exterior wall.

In one embodiment, the surface area of the aperture(s) present in an exterior wall of the trap of the invention represents from about 1.5% to about 40%, preferably from about 1.5% to about 20%, of the surface area of said exterior wall.

In one embodiment, the trap of the invention comprises more than one aperture as described hereinabove and said apertures all have the same size. In another embodiment, the trap of the invention comprises more than one aperture as described hereinabove and said apertures do not all have the same size.

In one embodiment, the total surface area of apertures present in the trap of the invention represents less than about 40%, 35%, 30%, 25%, 20%, 15%, 10%, 5% or 2.5% of the total surface area of said trap. In one embodiment, the total surface area of apertures present in the trap of the invention represents less than about 20%, 19%, 18%, 17%, 16%, 15%, 14%, 13%, 12%, 11%, 10%, 9%, 8%, 7%, 6%, 5%, 4%, 3%, 2%, 1.5%, 1% or 0.5% of the total surface area of said trap. In one embodiment, the total surface area of apertures present in the trap of the invention represents less than about 5% of the total surface area of said trap.

In one embodiment, the total surface area of apertures present in the trap of the invention represents from about 0.5% to about 40%, preferably from about 1% to about 30%, more preferably from about 1% to about 20% of the total surface area of said trap.

In one embodiment, the aperture of the invention is disposed or situated or positioned in a corner of the trap. In a particular embodiment, the aperture of the invention is disposed in an upper corner of the trap. Examples of apertures disposed in an upper corner of the trap are illustrated in FIG. 5.

In another embodiment, the aperture of the invention is not disposed or situated or positioned in a corner of the trap. In one embodiment, the aperture of the invention is disposed in one of the exterior walls of the trap.

In one embodiment, the aperture as described hereinabove is disposed or situated or positioned sensibly in the middle or center of an edge of the trap of the invention. In one embodiment, the aperture as described hereinabove is disposed in the middle or center of an edge of the trap of the invention. In one embodiment, an aperture disposed in the middle or center of an edge of the trap means that the center of the aperture overlaps with the center of said edge. An example of apertures disposed or situated or positioned sensibly in the middle or center of an edge of the trap of the invention is illustrated in FIG. 6.

Thus, in other words, in one embodiment, at least one edge of the trap of the invention comprises an aperture as described hereinabove disposed or situated or positioned sensibly in its middle or center, preferably in its middle or center.

In one embodiment, an aperture disposed or situated or positioned in the middle or center of an edge of the trap of the invention is a round aperture corresponding to the projection of a circle on the two exterior walls defining said edge. Thus, in one embodiment, an aperture disposed or situated or positioned in the middle or center of an edge of the trap of the invention is a round aperture formed of two half-circles straddling said edge.

Accordingly, in said embodiment, the two adjacent exterior walls of the trap of the invention forming the edge each comprises a semi-circular aperture.

In one embodiment, the trap of the invention comprises one, two, three, four, five, six, seven, eight, nine, ten, eleven or twelve aperture(s) as described hereinabove, preferably round aperture(s) as described hereinabove, each disposed in the middle or center of one of its edges. In one embodiment, the trap of the invention comprises four apertures as described hereinabove, preferably round apertures as described hereinabove, each disposed in the middle or center of one of its edges, preferably diagonally opposed edges. In one embodiment, the trap of the invention comprises six apertures as described hereinabove, preferably round apertures as described hereinabove, each disposed in the middle or center of one of its edges. In one embodiment, the trap of the invention comprises eight apertures as described hereinabove, preferably round apertures as described hereinabove, each disposed in the middle or center of one of its edges. In a particular embodiment, the trap of the invention comprises five exterior walls, and thus eight edges formed by two adjacent exterior walls, each edge comprising one aperture as described hereinabove, preferably a round aperture as described hereinabove, disposed in its middle or center.

In one embodiment, the trap of the invention comprises aperture(s) disposed sensibly in the middle or center of an edge of said trap as described hereinabove and interior walls which comprise notch(es) or nick(s) or gap(s) positioned in the middle or center of the edge(s) (or end(s) or extremity(ies)) of said interior walls that is/are in contact with an edge of the trap so that the aperture(s) in the edge(s) of the trap and the notch(es) of the interior wall(s) overlap or match or meet, thus allowing flying insects to enter the trap and move to either of the compartments delimited by the interior wall.

In one embodiment, the aperture as described hereinabove is disposed or situated or positioned sensibly in the middle or center of an exterior wall of the trap of the invention. In one embodiment, the aperture as described hereinabove is disposed or situated or positioned in the middle or center of an exterior wall of the trap of the invention. In one embodiment, an aperture disposed in the middle or center of an exterior wall of the trap of the invention means that the center of the aperture overlaps with the center of said exterior wall. An example of apertures disposed or situated or positioned sensibly in the middle or center of an exterior wall of the trap of the invention is illustrated in FIG. 7.

Thus, in other words, in one embodiment, at least one exterior wall of the trap of the invention comprises an aperture as described hereinabove disposed or situated or positioned sensibly in its middle or center, preferably in its middle or center.

In one embodiment, the trap of the invention comprises one, two, three, four, five or six aperture(s) as described hereinabove, preferably round aperture(s) such as a circular or oval aperture(s), each disposed in the middle or center of one of its exterior walls. In one embodiment, the trap of the invention comprises five exterior walls, each comprising one aperture as described hereinabove, preferably a round aperture such as a circular or oval aperture, disposed in the middle or center of the exterior wall. In one embodiment, the trap of the invention comprises six exterior walls, each comprising one aperture as described hereinabove, preferably a round aperture such as a circular or oval aperture, disposed in the middle or center of the exterior wall.

In one embodiment, the trap of the invention comprises aperture(s) disposed sensibly in the middle or center of an exterior wall of said trap and interior panel(s) reaching exterior wall(s) of the trap, said interior panel(s) comprising a notch or nick or gap positioned in the middle or center of the edge(s) (or end(s) or extremity(ies)) of said interior panels that is/are in contact with an exterior wall of the trap so that the aperture(s) in the exterior wall of the trap and the notch(es) of the interior panel(s) overlap or match or meet, thus allowing flying insects to enter the trap and move to either of the compartments delimited by the interior panel.

In another embodiment, the aperture of the invention corresponds to one of the face of the trap (also referred herein as an open trap). As an illustration, the trap of the invention may have the shape of a cube and only five exterior walls, the sixth face of the cube being an aperture. The same may apply to any shape of the trap. As another illustration, the trap of the invention may have the shape of a cube and only five exterior walls, the sixth face of the cube being the face in contact with the surface on or to which the trap is positioned or attached, e.g., a floor, a ceiling, a wall, the floor of a wardrobe, the top of a furniture.

In one embodiment, the trap of the invention comprises more than one aperture as described hereinabove and said apertures are all disposed similarly. Thus, in one embodiment, the trap of the invention comprises more than one aperture as described hereinabove and said apertures are all disposed in corners of the trap, in exterior walls of the trap, particularly in the middle or center of exterior walls of the trap, or in the middle or center of edges of the trap.

In another embodiment, the trap of the invention comprises more than one aperture as described hereinabove and said apertures are not all similarly disposed. Thus, in one embodiment, the trap of the invention comprises apertures that are disposed in corner(s) of the trap, in exterior wall(s) of the trap, particularly in the middle or center of exterior wall(s) of the trap, and/or in the middle or center of edge(s) of the trap.

In one embodiment, the external surface of the trap of the invention is made of a light-colored material. In one embodiment, the external surface of the trap is white, off-white, beige, light grey or pale color, such as pale yellow, pale pink, and the like.

In one embodiment, the external surface of the trap of the invention is made of a bright or reflecting, i.e., light reflective, material. As used herein, the term “bright colors” means sparkling, shimmering, luminous, glittering, shining, metallic, lighting, pearlescent or pearly colors, or colors with mirror effect. As used herein, the term “light reflective” means that the material reflects light, in particular visible light.

In a particular embodiment, the external surface of the trap of the invention is made of a bright light-colored material. As an illustration, the external surface of the trap of the invention may be pearl white, glittering white, metallic or silver light grey.

In another particular embodiment, the external surface of the trap of the invention is made of a bright or glittering dark-colored material. As used herein, the term “bright or glittering material” means a sparkling, shimmering, luminous, shining, metallic, lighting, pearlescent or pearly material, or a material with mirror effect. As an illustration, the external surface of the trap of the invention may be glittering brown, metallic brown or metallic dark grey.

In one embodiment, the external surface of the trap of the invention is fluorescent or phosphorescent. Accordingly, in one embodiment, the external surface of the trap of the invention is made of a fluorescent or phosphorescent material.

In one embodiment, the exterior walls of the trap of the invention are covered on the outside with a light-colored material. In one embodiment, said material is white, off-white, beige, light grey or pale color, such as pale yellow, pale pink, and the like.

In one embodiment, the exterior walls of the trap of the invention are covered on the outside with a bright or light reflective material. Examples of bright or light reflective materials include, without being limited to, aluminium.

In one embodiment, the exterior walls of the trap of the invention are covered on the outside and/or on the inside with an insulating material. Examples of insulating material include, without being limited to, fabric such as felt.

According to the present invention, any material covering the exterior walls of the trap of the invention, on the outside and/or on the inside, does not cover any aperture(s) present in said trap, notably in said exterior walls.

According to one embodiment, at least one exterior wall of the trap of the invention comprises at least one raised line or ridge radiating from the aperture(s) of the trap. According to one embodiment, at least one exterior wall of the trap of the invention comprises at least one furrow or groove radiating from the aperture(s) of the trap.

In one embodiment, said raised lines or ridges and/or said furrows or grooves are situated on the outside of the exterior walls(s) of the trap.

Without wishing to be bound by any theory, the Applicant suggests that flying insets move along said raised lines or ridges, or said furrows or grooves, towards the aperture(s) of the trap of the invention.

In one embodiment, an exterior wall comprising an aperture as described hereinabove comprises at least one raised line or ridge as described hereinabove and/or at least one furrow or groove as described hereinabove.

In one embodiment, the trap of the invention further comprises an attractive agent. In one embodiment, the attractive agent is an attractive agent for flying insects, preferably for ladybirds.

Examples of attractive agents include, but are not limited to, flower attractant compounds; flower extracts, such as marigolds, angelicas, dahlias or calendulas; cabbage extract; radish extract; diatomaceous earth; camphor or menthol extract; lavender extract; sexual attractants or pheromones; food attractants, and the like.

In one embodiment, the attractive agent is a non-toxic agent.

In one embodiment, the trap of the invention further comprises a sticky substance. In one embodiment, the sticky substance is disposed on the internal surface of at least one wall of the trap. Accordingly, in one embodiment, the internal surface of at least one wall is covered by a sticky substance. In one embodiment, the internal surface of at least one exterior wall and/or the surface of at least interior wall is covered by a sticky substance. In one embodiment, the internal surface of at least one exterior wall, the surface of at least interior wall and/or the surface of at least one interior panel is covered by a sticky substance. In one embodiment, the sticky substance is tacky glue or double-sided adhesive tape.

In one embodiment, the trap of the invention further comprises a desiccant substance, i.e., a substance which absorbs water. In one embodiment, the desiccant substance may be solid or liquid. In one embodiment, the desiccant substance may be coated on the interior surface of the trap. Examples of desiccant substance include, but are not limited to, powders such as talc, ordinary salt, activated charcoal, silicon dioxide, calcium sulfate (Drierite), calcium chloride, clay (preferably ultra-ventilated green clay or actapulgite), diatomaceous earth, and molecular sieves (for example, zeolites); or gels such as silica gel; or mixtures thereof.

In one embodiment, the trap of the invention does not comprise a light source. In one embodiment, the trap of the invention does not comprise a chemiluminescent light source.

In one embodiment, the trap is sized to the flying insects, preferably beetles, more preferably ladybirds, it is designed to trap.

In one embodiment, the trap of the invention is from about 2 cm wide to about 10 cm wide. In a particular embodiment, the trap of the invention is about 5 cm wide.

In one embodiment, the trap of the invention is from about 2 cm high to about 10 cm high.

In a particular embodiment, the trap of the invention is about 5 cm high.

In one embodiment, the trap of the invention is from about 2 cm long to about 15 cm long. In a particular embodiment, the trap of the invention is about 5 cm long. In another particular embodiment, the trap of the invention is about 10 cm long.

In a particular embodiment, the trap of the invention is a cube of 5 cm (i.e., 5 cm×5 cm×5 cm).

In one embodiment, the trap is of the invention is made of a rigid material. In one embodiment, the trap is of the invention is made of wood, plastic, paperboard, high density paperboard, laminated paperboard, metal such as aluminium, polystyrene, in particular expanded polystyrene or extruded polystyrene such as Styrofoam®, or combination thereof.

In one embodiment, the trap of the invention further comprises attachment means. Examples of attachment means include, but are not limited to, double-sided adhesive tape covered by release paper, hook, adhesive patch (such as for example Patafix, Blu-Tack or Tack-it), repositionable glue, rope, wire, pliers or clips, and the like.

In one embodiment, the double-sided adhesive tape is a light adhesive, for the traps to be disposable and the adhesive easily and completely released when the trap is removed.

In one embodiment, the trap is of the invention is such that it can be folded for convenient manufacturing, storage, and marketing. In one embodiment, the trap may be formed from a single material blank. Blank may have a plurality of predetermined fold lines along which it may be folded so as to form the trap. In one embodiment, the trap is of the invention is formed from two single material blanks or more. As an illustration, a first blank may be for exterior walls and a second blank may be for interior walls.

In one embodiment, the trap of the invention may be placed outdoor or indoor. In one embodiment, the trap of the invention may be placed in warm places. In one embodiment, the trap of the invention may be placed in sunny places. In one embodiment, the trap of the invention may be placed in places exposed to South, West, or South-West. In one embodiment, the trap of the invention may be placed in rooms such as bedrooms, kitchens, offices, corridors. In one embodiment, the trap of the invention may be placed outside of a house, for example against a wall, on or along a window frame, against a window, on a terrace, hung on a tree, etc. In one embodiment, the trap of the invention may be placed in agricultural areas, such as fields, vines, orchards, or greenhouses.

In one embodiment, the trap of the invention may be placed in a position where flying insects, preferably ladybirds, are likely to be found. In one embodiment, the trap of the invention may be placed in a room corner, preferably in an upper room corner. In another embodiment, the trap of the invention may be placed by windows or doors; along frames or walls; in ceilings or roofs.

In one embodiment, the trap of the invention may be placed in the vicinity of humans or animals.

In one embodiment, flying insects of the invention include, but are not limited to, beetles, flies, bees, wasps, moths, and the like.

In one embodiment, flying insects of the invention are beetles, belonging to the order Coleoptera.

In one embodiment, beetles of the invention include, but are not limited to, ladybirds, scarabs, clown beetles, jewel beetles, pill and turtle beetles, click and soldier beetles, fireflies, deathwatch beetles, powderpost beetles, skin beetles, leaf/flower beetles, checkered beetles and allies, longhorn beetles, weevils, and the like.

In one embodiment, flies of the invention include, but are not limited to, filth flies; house flies; bottle, blow, and flesh flies; fruit flies; vinegar flies; overwintering flies, such as cluster flies; biting flies, such as horse flies and deer flies, gnats and midges.

In one embodiment, bees of the invention include, but are not limited to, bumble bees, honey bees, and carpenter bees.

In a preferred embodiment, flying insects of the invention are ladybirds. As used herein, the term “ladybirds” may be replaced by “ladybugs” or “lady beetles”. In a particular embodiment, the ladybirds are Asian ladybirds (Harmonia axyridis).

The present invention also relates to a method for trapping flying insects, preferably ladybirds, comprising the step of providing a flying insect trap as described hereinabove.

In one embodiment, the method comprises the step of disposing the trap of the invention within a house. In one embodiment, the method comprises the step of disposing the trap of the invention against a wall. In one embodiment, the method comprises the step of disposing the trap of the invention in the corner of a room. In one embodiment, the method comprises the step of disposing the trap of the invention in an upper corner of a room.

In one embodiment, the method comprises the step of disposing the trap of the invention outside of a house. In one embodiment, the method comprises the step of disposing the trap of the invention against the external face of a window or a wall.

In one embodiment, the method comprises the step of disposing the trap of the invention in an agricultural area. In one embodiment, the method comprises the step of disposing the trap of the invention on vine plant. In one embodiment, the trap is hooked or hung from vine material, for example with rope, wire such as iron wire or clips.

The present invention will be discussed hereinafter in detail in terms of various exemplary embodiments according to the present invention with reference to the accompanying drawings. From the teaching of the detailed description, it will be obvious to those skilled in the art that the various exemplary embodiments may be combined together. For example, a trap according to the present invention comprising the intersecting interior walls of FIG. 2 may also comprise any of the apertures of FIG. 5-7. Similarly, a trap according to the present invention comprising the intersecting interior walls and interior panels of FIG. 4 may also comprise any of the apertures of FIG. 5-7. The intersecting interior walls of FIG. 2 or FIG. 4 may comprise the notches depicted on FIG. 3A.

In the detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “bottom”, “left”, “right”, “front”, “vertical”, “horizontal”, “parallel” and derivatives thereof shall relate to the invention as oriented in FIGS. 1-7.

Furthermore, there is no intention to be bound by any expressed or implied theory presented in the preceding technical field, background, brief summary or the following detailed description. It is also to be understood that the specific traps and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, there is a perspective view of a trap 1 according to a first exemplary embodiment of the invention. As illustrated in FIG. 1 a trap 1 of the invention may have a cuboid shape, exterior walls 2a and an interior wall 2b disposed between two opposite edges 3 of the trap 1. Therefore, according to this exemplary embodiment of the invention, the angle α between the interior wall 2b and each of its adjacent exterior wall 2a is 45°. According to this exemplary embodiment of the invention, the trap 1 of the invention comprises 4 angles α.

Referring to FIG. 2A, which is a perspective view of a second exemplary embodiment, a trap 1 of the invention may have a cuboid shape, exterior walls 2a and two interior walls 2b disposed between opposite edges 3 of the trap 1. Therefore, according to this exemplary embodiment of the invention, the two interior walls 2b are intersecting and form a line of intersection 5, and the angle α between each interior wall 2b and each of their adjacent exterior wall 2a is 45°. According to this exemplary embodiment of the invention, the trap 1 of the invention comprises 8 angles α.

Referring to FIG. 2B, which is a perspective view of a third exemplary embodiment, a trap 1 of the invention may have a cuboid shape, exterior walls 2a and two intersecting interior walls 2b disposed between opposite edges 3 of the trap thereby forming a line of intersection 5, at least one of the interior walls 2b being truncated in a corner.

Referring to FIG. 3A, which is a three-dimensional view of the intersecting interior walls 2b of a fourth exemplary embodiment, a trap of the invention may have two intersecting interior walls 2b forming a line of intersection 5, each interior wall 2b comprising two rounded notches 6 being situated each in the middle of an edge or end or extremity of the interior wall 2b.

Referring to FIG. 3B, which is a cross-sectional view of a fifth exemplary embodiment, a trap of the invention may have a cuboid shape, exterior walls 2a, two intersecting interior walls 2b and four interior panels 4c extending from the center of the trap towards the middle or center of an exterior walls 2a.

Referring to FIG. 4, which is a perspective view of the fifth exemplary embodiment, a trap 1 of the invention may have a cuboid shape, exterior walls 2a, two intersecting interior walls 2b disposed between opposite edges 3 of the trap and forming a line of intersection 5, and four interior panels 4c extending from the line of intersection 5 towards the middle or center of an exterior wall 2a. According to this exemplary embodiment of the invention, the angle α between each interior wall 2b and each of their adjacent exterior wall 2a, and between each interior panel 2c and each of their adjacent interior wall 2b is 45°. Thus, according to this exemplary embodiment of the invention, the trap 1 of the invention comprises 16 angles α.

Referring to FIG. 5A, there is a perspective view of a trap 1 according to a sixth exemplary embodiment of the invention, in which the trap 1 may have a cuboid shape, six exterior walls 2a and a rectangular aperture 4a disposed in a corner.

Referring to FIG. 5B, there is a perspective view of a trap 1 according to a seventh exemplary embodiment of the invention, in which the trap 1 may have a cuboid shape, 6 exterior walls 2a and a triangular aperture 4b disposed in a corner.

Referring to FIG. 5C, there is a perspective view of a trap 1 according to an eight exemplary embodiment of the invention, in which the trap 1 may have a cuboid shape, 6 exterior walls 2a and two triangular apertures 4b disposed in two different corners.

Referring to FIG. 6A, there is a perspective view of a trap 1 according to a ninth exemplary embodiment of the invention, in which the trap 1 may have a cuboid shape, six exterior walls 2a and a round aperture 4c disposed in the middle of an edge 3 of the trap, said round aperture 4c corresponding to the projection of a circle on the two exterior walls 2a defining the edge 3 of the trap.

Referring to FIG. 6B, there is a perspective view of a trap 1 according to a tenth exemplary embodiment of the invention, in which the trap 1 may have a cuboid shape, six exterior walls 2a and eight round apertures 4c, each being disposed in the middle of an edge 3 of the trap and corresponding to the projection of a circle on the two exterior walls 2a defining the edge 3 of the trap. Therefore, according to this exemplary embodiment of the invention, all the edges 3 of the trap except for the four edges at the bottom of the trap comprise a round aperture 4c disposed in their middle.

Referring to FIG. 7A, there is a perspective view of a trap 1 according to an eleventh exemplary embodiment of the invention, in which the trap 1 may have a cuboid shape, six exterior walls 2a and a round aperture 4d disposed in the middle of an exterior wall 2a of the trap.

Referring to FIG. 7B, there is a perspective view of a trap 1 according to a twelfth exemplary embodiment of the invention, in which the trap 1 may have a cuboid shape, six exterior walls 2a and six round apertures 4d, each being disposed in the middle of an exterior wall 2a of the trap. Therefore, according to this exemplary embodiment of the invention, all the exterior walls 2a of the trap comprise a round aperture 4d disposed in their middle.

Alternatives of FIGS. 1, 2 and 4 may be realized with a front exterior wall.

### REFERENCES

1 Trap
2a—Exterior wall
2b—Interior wall
2b—Interior panel
3—Edge
4a—Rectangular aperture
4b—Triangular aperture
4c—Round aperture positioned in the middle of an edge of the trap
4d—Round aperture positioned in the middle of an exterior wall of the trap
5—Line of intersection formed by two intersecting interior walls
Rounded notch positioned in the middle of an edge (or end or extremity) of an interior wall

### EXAMPLES

The present invention is further illustrated by the following examples.

Rearing

Harlequin ladybirds (Harmonia axyridis) were reared in plastic boxes containing filter paper folded in accordion fashion to provide a refuge. Individuals were collected from houses during autumn (from September to December). Specimens were collected from infested dwellings, including inside window and door frames, or on walls and windows, where individuals had aggregated to overwinter. Individuals were placed in the room at a temperature of 18° C. and an 8 h light/16 h dark photoperiod without any food or water, to replicate aggregation conditions.

### Example 1: Cuboid Traps with Interior Walls

### Experiment 1

Material Et Methods

A cross made of balsam was introduced within a cube of 5×5×5 cm (high×length×width), thereby providing angles of 45°. The resulting trap thus comprised two interior walls crossing each other, each interior wall disposed between two opposite edges. Two triangular apertures were formed in two corners of the trap. The trap was placed in the corner of a box (30 cm length, 6 cm high, 8 cm width) containing 20 ladybird individuals. Position of individuals was noted after 1 h and after 1 week (N=3).

Results

After 1 h, 80% of individuals have entered into the trap. After 1 week, efficiency reached 95% (CHI²=48.6, p-value=0). Therefore, a cubic trap comprising interior walls disposed between opposite edges, i.e., a cuboid shape comprising interior acute angles, shows a very high efficiency in a very short period of time (as from 1 h).

### Experiment 2

Material and Methods

The experimental procedure is the same as above Experiment 1, except that the cubic trap was placed in a vivarium (30 cm length, 40 cm high, 30 cm width, for a total area of 36000 cm³) containing 20 ladybird individuals. The trap was fixed in an upper corner with double-sided adhesive tape. Position of individuals was noted for the 4 first hours and after 24 h (N=2).

Results

Results are presented in FIG. 8. After 2 h, 80% of the individuals are sheltered in the trap (CHI²=14.4, p-value=0.0001). After 24 h, 87.5% of individual have entered into the trap (CHI²=22.5, p-value=0).

Therefore, traps of the invention show a very high effectiveness.

### Example 2: Optimum for Angles of the Trap

Material and Methods

Traps with different angles (10°, 30°, 45°, 60°, 90° and 135°) were tested. They were fixed in plastic boxes (same as Example 1) with double-sided adhesive tape. Position of individuals was noted after 6 h. Three repetitions were performed per angle.

Results

Results are presented in FIG. 9. After 6 h, 93% of individual have entered into traps with angle of 45° (CHI²=22.5333, p-value=0). All other tested angles lead to a significantly lower percentage of individuals after 6 h. As represented in FIG. 9, the percentage dropped to 60% with an angle of 30°, to 53.3% with an angle of 60% and to 46.7% with an angle of 10°. No individuals were counted in traps with an angle of 90° or 135°.

These results demonstrate a preference of ladybirds to acute angles. In particular, ladybirds are more attracted to angles of about 45°.

### Example 3: Position of the Apertures of the Trap

Rearing

Harlequin ladybirds (Harmonia axyridis) were reared in plastic boxes containing a moistened sponge, pollen and sugar. Individuals were collected in the field in the spring and summer and were placed in the room at a temperature of 20-25° C. and an 8 h light/16 h dark photoperiod.

Material Et Methods

A cross-shaped brace made of plastic was introduced within cubes of 5×5×5 cm (high×length×width), thereby providing angles of 45°. The brace was covered with glue. The resulting traps comprised five exterior walls and two intersecting interior walls, each interior wall disposed between opposite edges. The exterior walls of each trap were covered with aluminium foil. The traps each comprised four round apertures with a diameter of 1 cm, the four round apertures each being positioned either in the middle of an exterior wall of the trap or the four round apertures each being positioned in the middle of an edge of the trap (thus forming two half-circles straddling the edge). Thus, the traps comprised either four exteriors walls with a round aperture or four edges with a round aperture.

Each trap was placed in a box (30 cm length, 10.5 cm high, 20 cm width) containing 10 ladybird individuals. The trap was attached at a height of 4 cm to a wall of the plastic box with a hot melt-glue applicator. The sixth face of the trap was thus closed by the wall of the plastic box to which the trap was attached. Each trap was tested separately (N=4) in a room at 20-25° C. Position of individuals was noted after 72 h. Statistical significance was assessed using a Fisher's exact test.

Results

Efficiency is expressed as the mean percentage (±SD) of ladybugs individuals sheltered within the traps with respect to the total number of ladybug individuals present in the plastic box (four experiments for each type of traps were carried out).

Ladybugs sheltered both in the traps wherein the four apertures are positioned in the middle of an exterior wall of the trap and in the traps wherein the four round apertures are positioned in the middle of an edge of the trap.

As shown in FIG. 10, after 72 h, the traps with apertures each positioned in the middle of an exterior wall and the traps with apertures each positioned in the middle of an edge showed the same mean efficiency (Fisher's test, p-value=1.00).

### Example 4: Number of Apertures

Rearing

Harlequin ladybirds (Harmonia axyridis) were reared as described in Example 3.

Material and Methods

A cross-shaped brace made of plastic was introduced within cubes of 5×5×5 cm (high×length×width), thereby providing angles of 45°. The resulting traps comprised five exterior walls and two intersecting interior walls, each interior wall disposed between opposite edges. The exterior walls of each trap were covered with aluminium foil. The traps comprised 4, 6 or 8 round apertures with a diameter of 1 cm, each aperture being positioned in the middle of an edge of the trap. Thus, the traps comprised either 4, 6 or 8 edges with a round aperture.

Each trap was placed in a box (30 cm length, 10.5 cm high, 20 cm width) containing 10 ladybird individuals. The trap was attached at a height of 4 cm to a wall of the plastic box with a hot melt-glue applicator. The sixth face of the trap was thus closed by the wall of the plastic box to which the trap was attached. Each trap was tested separately (N=3) in a room at 20-25° C. Position of individuals was noted after 2, 4, 8, 18, 24 and 28 h. Statistical significance was assessed using a Fisher's exact test.

Results

As shown in Table 1 below and in FIG. 11, the number of individuals in the traps were assessed after 2, 4, 8, 18, 24 and 28 h.

Efficiency is expressed as the mean percentage (±S.D) of ladybugs individuals sheltered within the indicated type of trap with respect to the total number of ladybug individuals present in the plastic box (three experiments for each type of traps were carried out).

TABLE 1
Number of apertures within a trap

| | Mean efficiency (%) | | |
|---|---|---|---|
| | 4 apertures | 6 apertures | 8 apertures |
| 2 H | 7 (±5.8) | 13 (±5.8) | 21 (±10.1) |
| 4 H | 13 (±5.8) | 17 (±5.8) | 38 (±16) |
| 6 H | 13 (±5.8) | 33 (±20.8) | 57 (±23.1) |
| 24 H | 37 (±5.8) | 33 (±11.5) | 63 (±11.5) |
| 28 H | 33 (±5.8) | 47 (±15.3) | 86 (±5.2) |

After 28 h, 86% of the ladybugs had entered the trap having 8 apertures, while 47% and 33% of individuals had entered the traps having 6 and 4 apertures, respectively. The mean efficiency of the trap with 8 apertures was statistically higher than that of the other traps (Fisher's exact test: 8 apertures vs 6 apertures, p-value=0.015; 8 apertures vs 4 apertures, p-value=0.0006). There was no significant difference between the efficiencies of the other two traps (4 vs 6 apertures, Fisher's exact test, p-value=0.429).

### Example 5: Size of Apertures

Rearing

Harlequin ladybirds (Harmonia axyridis) were reared as described in Example 3.

Material and Methods

As described in Example 4, a cross-shaped brace made of plastic was introduced within cubes of 5×5×5 cm (high×length×width), thereby providing angles of 45°. The resulting traps comprised five exterior walls and two intersecting interior walls, each interior wall disposed between opposite edges. The exterior walls of each trap were covered with aluminium foil. The traps each comprised eight round apertures, each aperture being positioned in the middle of an edge of the trap. Thus, the traps comprised 8 edges with a round aperture. Within a given trap, the size of each of the 8 apertures was of 5, 7, 9, 13 or 25 mm of diameter.

Each trap was placed in a box (30 cm length, 10.5 cm high, 20 cm width) containing 10 ladybird individuals. The trap was attached at a height of 4 cm to a wall of the plastic box with a hot melt-glue applicator. The sixth face of the trap was thus closed by the wall of the plastic box to which the trap was attached. Each trap was tested separately (N=4) in a room at 20-25° C. Position of individuals was noted after 2, 4, 6, 24, 28, 30 and 48 h. Statistical significance was assessed using a Fisher's exact test.

Results

As shown in Table 2 below and in FIG. 12, the number of individuals in the traps were assessed after 2, 4, 6, 24, 28, 30 and 48 h.

Efficiency is expressed as the mean percentage (±SD) of ladybugs individuals sheltered within the indicated type of trap with respect to the total number of ladybug individuals present in the plastic box (four experiments for each type of traps were carried out).

TABLE 2
Size of the apertures within a trap

| | Mean efficiency (%) | | | | |
|---|---|---|---|---|---|
| | 5 mm | 7 mm | 9 mm | 13 mm | 25 mm |
| 2 H | 0 | 0 | 3 (±5.7) | 10 (±6.3) | 5 (±7) |
| 4 H | 0 | 3 (±4.3) | 17 (±5.7) | 18 (±7.5) | 5 (±5.7) |
| 6 H | 0 | 10 (±10) | 27 (±15.3) | 33 (±12.1) | 15 (±5.7) |
| 24 H | 2 (±4.3) | 27 (±13) | 45 (±13.4) | 43 (±10.3) | 31 (±12.9) |
| 28 H | 2 (±4.3) | 31 (±6.4) | 44 (±22.1) | 45 (±18.7) | 41 (±12.6) |
| 30 H | 2 (±4.3) | 31 (±6.4) | 66 (±14.3) | 48 (±17.2) | 31 (±13.1) |
| 48 H | 2 (±4.3) | 49 (±16.8) | 59 (±16.4) | 56 (±8.16) | 24 (±18) |

Very few ladybugs sheltered in the traps with round apertures of a diameter of 5 mm. After 48 hours, about 50-60% of the ladybugs had entered the traps having apertures of 7, 9 or 13 mm. As shown in Table 2 and in FIG. 12, significantly less individuals were found in traps having round apertures of a diameter of 5 mm and in traps having round apertures of a diameter of 25 mm.

As shown in Table 3 below, the mean efficiency of each tested trap after 48 hours was compared to that of the others.

TABLE 3
Comparison of the mean efficiencies of the tested traps
Fisher's exact test results

| | 5 mm | 7 mm | 9 mm | 13 mm | 25 mm |
|---|---|---|---|---|---|
| 5 mm | — | | | | |
| 7 mm | p < 0.0001 | — | | | |
| 9 mm | p < 0.0001 | p = 0.62 | — | | |
| 13 mm | p < 0.0001 | p = 0.66 | p = 1.00 | — | |
| 25 mm | p = 0.005 | p = 0.02 | p = 0.01 | p = 0.02 | — |

### Example 6: Number of Angles of 45°

Rearing

Harlequin ladybirds (Harmonia axyridis) were reared as described in Example 3.

Material and Methods

Traps comprising either 8 or 16 angles of 45° were tested. As described in Example 4, a cross made of plastic was introduced within cubes of 5×5×5 cm (high×length×width), thereby providing 8 angles of 45°. The resulting traps comprised five exterior walls and two intersecting interior walls, each interior wall disposed between opposite edges. A double cross made of plastic, illustrated in FIG. 3B, was introduced within cubes of 5×5×5 cm (high×length×width), thereby providing 16 angles of 45°. The resulting traps comprised five exterior walls; two intersecting interior walls, each interior wall disposed between opposite edges; and four interior panels as illustrated in the embodiment of FIG. 4. The traps each comprised eight round apertures with a diameter of 1 cm, each aperture being positioned in the middle of an edge of the trap. The exterior walls of each trap were covered with aluminium foil.

Each trap was placed in a box (30 cm length, 10.5 cm high, 20 cm width) containing 10 ladybird individuals. The trap was attached at a height of 4 cm to a wall of the plastic box with a hot melt-glue applicator. The sixth face of the trap was thus closed by the wall of the plastic box to which the trap was attached. Each trap was tested separately (N=3) in a room at 20-25° C. Position of individuals was noted after 2, 4, 6, 8, 24, 28 and 48 h. Statistical significance was assessed using a Fisher's exact test.

As shown in Table 4 below and in FIG. 13, the number of individuals in the traps were assessed after 2, 4, 6, 8, 24, 28 and 48 h.

Efficiency is expressed as the mean percentage (±SD) of ladybugs individuals sheltered within the indicated type of trap with respect to the total number of ladybug individuals present in the plastic box (three experiments for each type of traps were carried out).

TABLE 4
Number of angles of 45°

Efficiency (%)

| | 8 angles of 45° | 16 angles of 45° |
|---|---|---|
| 2 H | 3 (±5.8) | 23 (±25.2) |
| 4 H | 7 (±5.8) | 30 (±26.5) |
| 6 H | 20 (±17.3) | 47 (±30.6) |
| 8 H | 37 (±32.1) | 63 (±28.9) |
| 24 H | 53 (±5.8) | 73 (±30.6) |
| 28 H | 40 (±0) | 53 (±37.9) |
| 48 H | 59 (±18.9) | 85 (±17) |

Ladybugs sheltered both in the traps with 8 angles of 45° and in the traps with 16 angles of 45°.

After 48 hours, significantly more ladybugs were sheltered in the trap having 16 angles (Fisher's exact test, p-value=0.0379).

1. A flying insect trap having a cuboid shape and comprising at least two intersecting interior walls, each interior wall forming an acute angle with at least one exterior wall of the trap, wherein said at least two interior walls are disposed between two edges of opposite exterior walls of the trap.

2. The flying insect trap according to claim 1, wherein said intersecting interior walls are plane walls.

3. The flying insect trap according to claim 1, wherein the line of intersection formed by the two intersecting interior walls is continuous on at least 50% of its length, preferably at least 75% of its length.

4. The flying insect trap according to claim 1, wherein said trap further comprises at least one interior panel forming an acute angle with at least one interior wall.

5. The flying insect trap according to claim 4, wherein said trap comprises four interior panels.

6. The flying insect trap according to claim 1, wherein the external surface of said trap is light colored.

7. The flying insect trap according to claim 1, wherein the external surface of said trap is light reflective.

8. The flying insect trap according to claim 1, wherein said trap comprises an aperture disposed in a corner of the trap, an aperture disposed in the middle of an edge of the trap and/or an aperture disposed in the middle of an exterior wall of the trap.

9. The flying insect trap according to claim 8, wherein said aperture is a rectangular aperture, a triangular aperture or a round aperture.

10. The flying insect trap according to claim 8, wherein the total surface area of aperture(s) present in said trap represents less than about 40% of the total surface area of said trap, preferably less than about 30% of the total surface area of said trap.

11. The flying insect trap according to claim 1, wherein the internal surface of at least one exterior wall or the surface of at least interior wall is covered by a sticky substance.

12. The flying insect trap according to claim 1, further comprising an attractive agent.

13. The flying insect trap according to claim 1, further comprising a desiccant substance.

14. The flying insect trap according to claim 1, wherein said flying insect is a beetle.

15. The flying insect trap according to claim 14, wherein said beetle is a ladybird.

16. A method for trapping flying insects, wherein said method comprises a step of providing a flying insect trap as defined in claim 1.
